(19) United States
(12) Patent Application Publication
(10) Pub. No.: US 2004/0016608 A1
(43) Pub. Date: Jan. 29, 2004

(54) Brake backing plate and method and apparatus for making same

(76) Inventor: Vladyslaw Gutowski, Kirkfield (CA)

Correspondence Address: WHITE & CASE LLP, PATENT DEPARTMENT, 1155 AVENUE OF THE AMERICAS, NEW YORK, NY, 10036, US

(21) Appl. No.: 10/600,385

(22) Filed: Jun. 19, 2003

Related U.S. Application Data
(60) Provisional application No. 60/390,250, filed on Jun. 20, 2002.

(51) Int. Cl. F16D 65/00

(52) U.S. Cl. 188/73.1

(57) ABSTRACT

A brake backing plate has a friction surface for receiving a friction pad material. The brake backing plate has multiple protrusions are protruding out of the friction surface. One or more protrusions have an enlarged section for facilitating engagement between the friction surface and the friction pad material. In an embodiment, the enlarged section is formed by pressing the distal end of one or more protrusions.

This invention relates to the field of brake backing plates, and more, particularly, to a brake backing plate and method and apparatus for making same.

### BACKGROUND OF THE INVENTION

It is common to manufacture a brake using a friction pad mounted on a brake backing plate. In this type of brakes, it is important to secure engagement between the brake backing plate and the friction pad so that they do not separate under high shear forces during braking operations.

To facilitate engagement between the friction pad and the brake backing plate, it is known to provide protrusions and recesses or holes on a surface of the brake backing plate. The friction pad material surrounds the protrusions and also enters into the recesses or holes, which provides improved engagement between the friction pad and the brake backing plate.

### SUMMARY OF THE INVENTION

It is an object of the invention to provide a novel brake backing plate that provides further improved engagement with a friction pad mounted on the brake backing plate.

The present invention provides a deformed section on a protrusion projecting out of a surface of a brake backing plate which receives a friction pad material thereon.

In accordance with an aspect of the present invention, there is provided a brake backing plate comprising a friction surface for receiving a friction pad material thereon; and multiple protrusions protruding out of the friction surface, one or more of which protrusions have an enlarged section for facilitating engagement between the friction surface and the friction pad material.

In accordance with another aspect of the present invention, there is provided a brake backing plate treating apparatus comprising a protrusion forming unit having multiple blades for forming multiple protrusions on a friction surface of a brake backing plate which receives a friction pad material thereon; and a deforming unit for deforming one or more protrusions formed by the protrusion forming unit to provide an enlarged-section on one or more protrusions for facilitating engagement between the friction surface and the friction pad material.

In accordance with another aspect of the present invention, there is provided a method for treating brake backing plates, the method comprising steps of forming multiple protrusions on a friction surface of a brake backing plate which receives a friction pad material; and deforming one or more protrusions to provide an enlarged deformed section on the one or more protrusions for facilitating engagement between the friction surface and the friction pad material.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a perspective view of a brake backing plate in accordance with an embodiment of the invention;

FIG. 2 is an enlarged view of a portion of the brake backing plate;

FIG. 3 is a diagram schematically showing an apparatus for making brake backing plates in accordance with an embodiment of the invention;

FIG. 4 is a diagram showing an apparatus for making brake backing plates in accordance with an embodiment of the invention; and

FIG. 5 is a diagram showing a side view of the dies in the apparatus of FIG. 4.

### DETAILED DESCRIPTION OF THE PREFERRED EMBODIMENTS

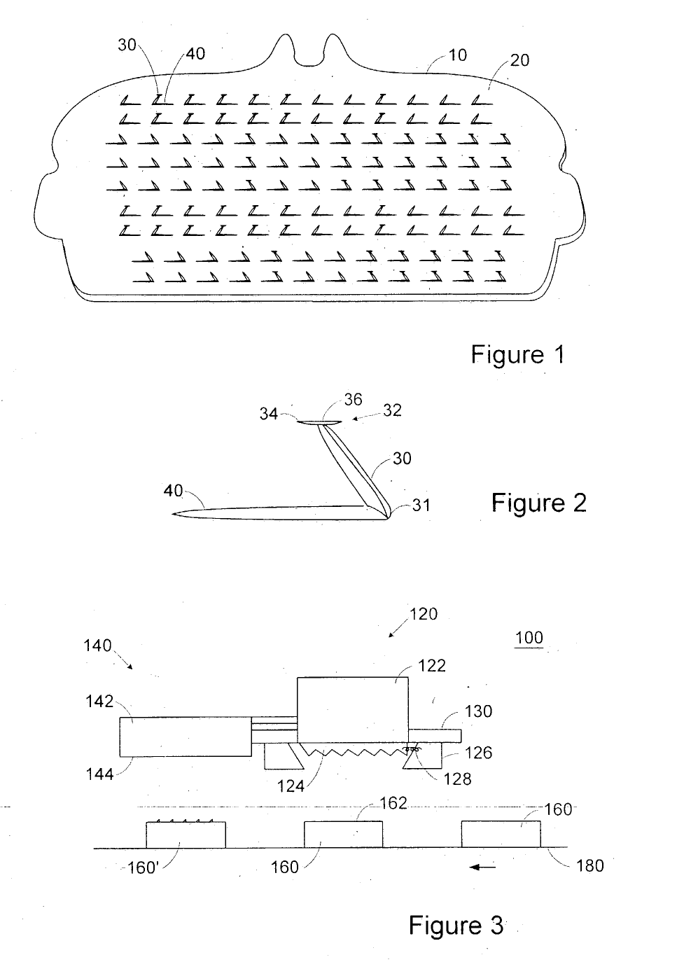

Referring to FIGS. 1 and 2, a brake backing plate in accordance with an embodiment of the present invention is described. The brake backing plate 10 has a friction surface 20 which receives a friction pad material thereon. The brake backing plate 10 is typically manufactured of metal or metal composition. The peripheral configuration and the thickness of the brake backing plate 10 may be varied to suit to the purpose of the backing plate 10.

On the friction surface 20, multiple protrusions 30 are provided. As shown in FIG. 2, each protrusion 30 has a proximal end 31 where the protrusion 30 is protruding out of the friction surface 20 and a distal end 32 opposing to the proximal end 31. The protrusions 30 may be uniformly distributed throughout the majority of the friction surface 20, or may be distributed irregularly on the friction surface 20. They may be distributed in a predetermined section or sections of the friction surface 20. The protrusions 30 may have generally the same shape and size throughout the friction surface 20, or some or all protrusions 30 may have different shapes and/or different sizes. In the embodiment shown in FIG. 1, the protrusions 30 and recesses 40 are provided in multiple rows, and the protrusions 30 in some rows protrude in a direction opposite to the protrusions in the remainder of rows. However, the protrusions may be arranged in different manners and protrude in different directions.

It is preferable that each protrusion 30 is formed by cutting or displacing a portion out of the friction surface 20 so that the protrusion 30 is formed integrally with the backing plate 10. In this case, forming a protrusion results in forming a corresponding recess 40. When a protrusion 30 is formed by cutting out of the friction surface 20 using a blade having an angled cutting surface, the protrusion 30 typically has a narrower distal 32 end and a wider proximal end 31, i.e, the cross sectional area of the protrusion 30 diminishes from the proximal end 31 towards the distal end 32 of the protrusion 30, as better seen in FIG. 2. In a different embodiment, protrusions may have different general shapes and sizes.

As shown in FIG. 2, the distal end 32 of the protrusion 30 is deformed such that a deformed section 34 of an enlarged cross sectional area is formed. When a friction pad material is mounted on the friction surface 20, the friction pad material surrounds the deformed section 34 of the protrusion 30 as well as the reminder section of the protrusion 30. Thus, when a shear force is exerted on the friction pad material, the enlarged deformed section 34 anchors the friction pad material and further facilitates engagement and retention of the friction pad material on the friction surface 20.

The deformed section 34 does not have to be evenly enlarged in every direction. The deformed section 34 may be enlarged in generally radially from the length of the protrusion, or may be enlarged in a certain direction more than in other directions. In the embodiment shown in FIG. 2, the deformed section 34 is enlarged in generally parallel to the friction surface 20 and has a flat top surface 36. This type of deformed section 34 may be efficiently formed by pressing the distal end 32 of the protrusion 30 with a flat surface. When the deformed section 34 is formed by pressing, the peripheral and/or lower surface of the deformed section 34 typically stays rough or unsmoothened, which further facilitate engagement between the friction pad material and the backing plate 10. The top surface may take a different shape when it is pressed with a different surface.

The degree of deformation may be adjusted depending on the type of friction pad material, the distribution of the protrusions, the location of the deformed sections, the purpose of the brake backing plate and/or other factors.

In an embodiment, all protrusions 30 on a backing plate 10 may be deformed to have the deformed section 34. However, in a different embodiment, it is not necessary to deform every protrusion 30 on a backing plate 10. Also, the degree of deformation does not have to be the same throughout a backing plate 10. Different protrusions 30 in a backing plate 10 may have deformed portions of different shapes and different degree of deformation.

Also, in the embodiment shown in FIG. 2, the enlarged section 34 is formed at the distal end of the protrusions. In a different embodiment, an enlarged section may be formed in a different position of a protrusion. It is typically preferable to provide an enlarged section at or close to the distal end to provide better anchor effects. However, similar anchor effects may be achieved with an enlarged section provided apart from the distal end When the protrusion is long.

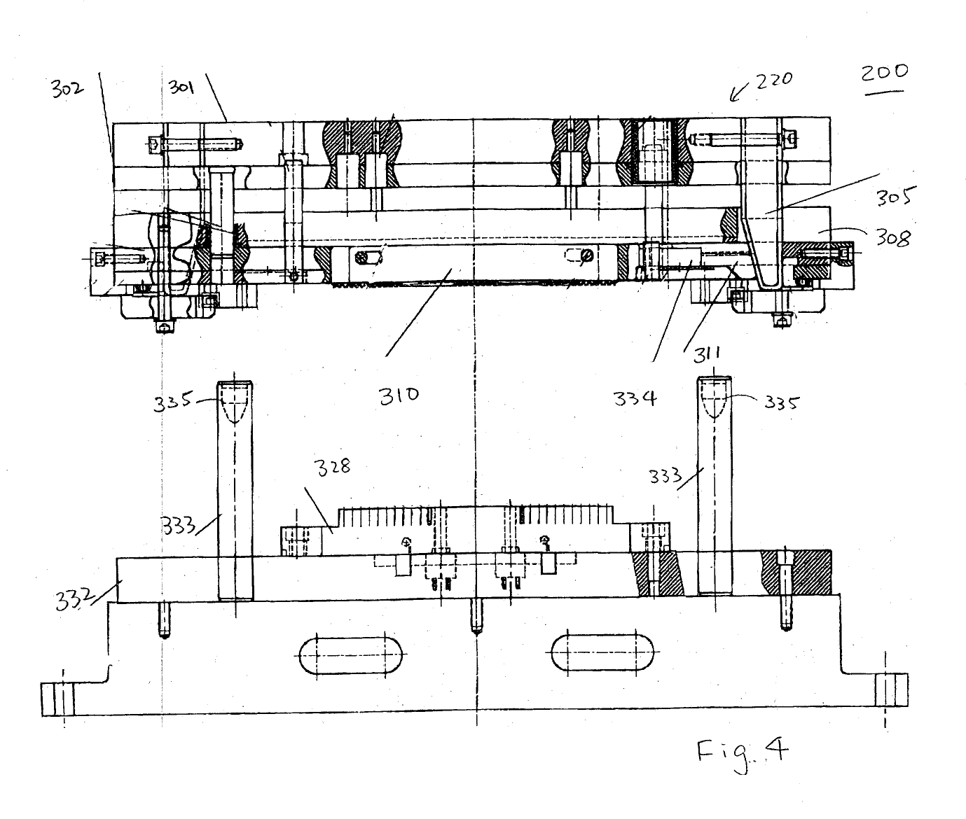

FIG. 3 shows an apparatus for treating friction surfaces of brake backing plates in accordance with an embodiment of the invention. The apparatus 100 comprises a protrusion forming unit 120 and a deforming unit 140. Plates 160 which are configured in a brake backing-plate shape are carried by a conveyer 180 through the protrusion forming unit 120 and the deforming unit 140.

The protrusion forming unit 120 has a press 122, blades 124 and a blade sliding member 126. The press 122 is provided to press the blades 124 onto a friction surface 162 of a plate 160 which is conveyed in the protrusion forming unit 120. While blades 124 are pressed onto the plate 160, the blade sliding member 126 causes the blades 124 to move generally in a direction perpendicular to the pressing direction by the press 122 for a predetermined distance. Thus, blades 124 cut and displace portions of the friction surface 162 of the plate 160 to form protrusions and corresponding recesses on the friction surface 162. The sliding member 126 may be an inclined surface or surfaces, along which blades 124 travels as they are pressed downwardly by the press 122. A support 130 may be provided to support the sliding member 128 stationary relative to the plate 160 while the press presses the blades 124 on the friction surface 162 of the plate 160. Alternatively, a sliding member or members may be provided on a base which supports the plate 160.

Each blade 124 preferably has a series of cutting edges so that multiple protrusions and recesses are formed in a row by a single blade 124. Multiple blades 124 may be arranged side by side, so that with one stroke of the pressing movement by the press 122, the blades 124 can form a matrix of protrusions and recesses on the friction surface 162 of the plate 160.

The multiple blades 124 may be provided such that one group of blades faces an opposite direction to another group of blades. In that case, the protrusion forming unit 120 preferably has a set of blade sliding members 126 to move those two groups of blades in opposite directions by a single stroke of the pressing movement by the press 122, so that opposing protrusions are formed as shown in FIG. 1.

The blades 124 are urged by a biassing member 128 to return to the initial position when the pressing forces by the press 122 are removed.

The deforming unit 140 receives the plate 160 which is treated by the protrusion forming unit 120. The deforming unit 140 has a deforming plate 142. The deforming plate 142 is connected to and activated by the press 122 of the protrusion forming unit 120. It may be connected to the press 122 directly or through an arm or other members.

The deforming plate 142 is located such that when it is brought down by the press 122, a lower surface 144 of the deforming plate 142 presses and deforms distal ends of some or all protrusions formed by the protrusion forming unit 120. It may have a mechanism to adjust the position of the deforming plate 142 relative to the friction surface 162 of the plate 160 so that the degree of the deformation can be changed.

The lower surface 144 of the deforming plate 142 is preferably flat when generally even deformation throughout is desirable. It may be in a different shape or angled when a particular distribution of deformed protrusions are desirable.

In operation, the conveyer 180 carries a first plate 160 into the protrusion forming section 120. The press 122 presses the blades 124 to form protrusions and recesses on the friction surface 162 of the first plate 160 in cooperation with the blade sliding member 126.

The conveyer 180 conveys the first plate 160 into the deforming unit 140 at the same time it conveys a second plate 160′ into the protrusion forming unit 120. The pressing action of the press 122 form protrusions and recessions on the second plate 160′ as well as deform the protrusions of the first plate 160 in the deforming unit 140.

In the embodiment shown in FIG. 3, the deforming plate 142 is activated by the press 122 of the protrusion forming unit 120. In a different embodiment, the deforming unit 140 may have a press to activate the deforming plate 142 independent from the protrusion forming unit 120. In that case, it is preferable to synchronize the activation of the deforming plate 142 and the press 122 of the protrusion forming unit 120, so that plates 160 can be conveyed in a synchronised manner by a single conveyer 180.

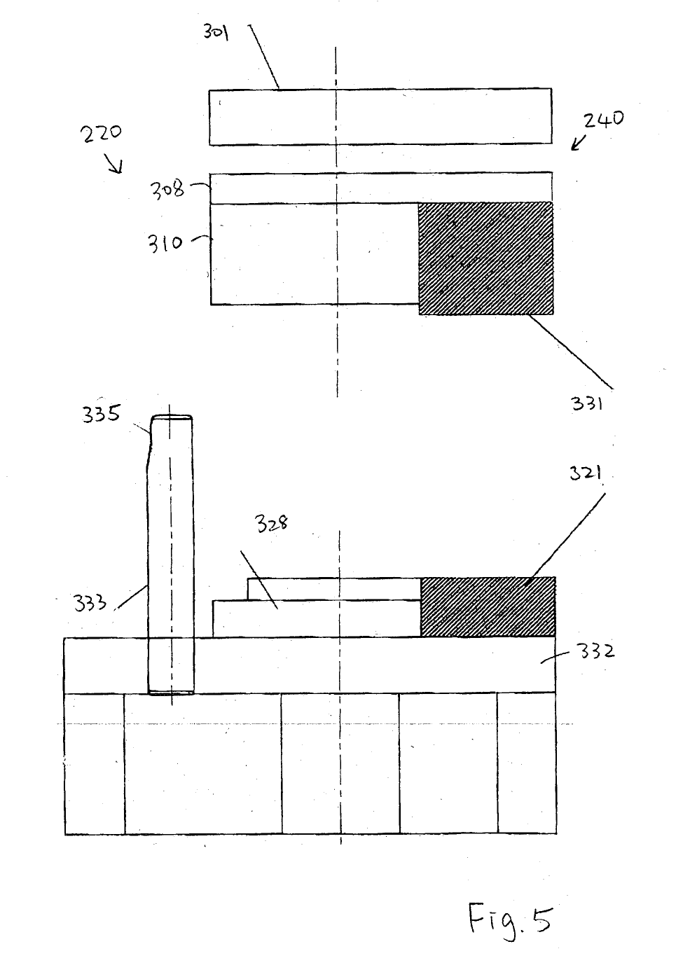

Referring now to FIGS. 4 and 5, an apparatus 200 for treating friction surfaces of brake backing plates in accordance with another embodiment of the invention is described. The apparatus 200 comprises a protrusion forming section 220 and a deforming or squizzing section 240. FIG. 4 illustrating a front view of the apparatus 200. The protrusion forming section 200 is better seen in this figure. FIG. 5 illustrates a side view of the apparatus 200. The deforming section 240 is better seen in this figure.

The apparatus 200 has a base plate 301, cam holder plate 302, cam 305, blade support 308, blades 310, blade support arm 311, die plate 328, top plate 331, bottom plate 321, bottom base 332, special die pins 333 and springs 334.

The base plate 301 holds blade support 308 and activates it using the cam 305 held by the cam holder plate 302. The blade support 308 supports the blades 310 through the blade support arm 311. The blades 310 are urged to their initial positions by the springs 334.

A brake backing plate to be treated is provide on the die plate 328 provided on the bottom base 322.

The special die pins 333 are provided on the bottom base 322 upwardly. Each pin 333 has a sliding surface 335 on the upper end. The blade support arm 311 has a corresponding protrusion such that the blade'support arm 311 slides on the sliding surface 335 to cause a side movement of the blades 310 when the cam 305 bring them downward to form protrusions on the top surface of the brake backing plate held on the die plate 328.

As shown in FIG. 5, in the deforming section 240, the top plate 331 and bottom plate 321 are used to deform or squiz protrusions formed on the surface of the backing plate in the protrusion forming section 220.

The bottom plate 321 is provided on the bottom base 332 adjacent to the die plate 328. The bottom plate 321 supports the backing plate received from the protrusion forming section 220.

The top plate 331 is supported by the blade support 308 so that the top plate 331 is activated together with the blades 310. The cam system and other elements are omitted in FIG. 5 for the purpose of simplicity of the drawing.

While particular embodiments of the present invention have been shown and described, changes and modifications may be made to such embodiments without departing from the true scope of the invention.

What is claimed is:

1. A brake backing plate comprising:
a friction surface for receiving a friction pad material thereon; and
multiple protrusions protruding out of the friction surface, one or more of which protrusions have an enlarged section for facilitating engagement between the friction surface and the friction pad material.

2. The brake backing plate as claimed in claim I wherein each protrusion has a proximal end where the protrusion is protruding out of the friction surface and a distal end opposing to the proximal end, and the enlarged section is formed at the distal end of one or more protrusions.

3. The brake backing plate as claimed in claim 1 wherein the enlarged section is deformed to have an enlarged cross sectional area.

4. The brake backing plate as claimed in claim 1 wherein the enlarged section is enlarged in generally parallel to the friction surface.

5. The brake backing plate as claimed in claim 1 wherein the enlarged section has a flat surface.

6. A brake backing plate treating apparatus comprising:
a protrusion forming unit having multiple blades for forming multiple protrusions on a friction surface of a brake backing plate which receives a friction pad material thereon; and
a deforming unit for deforming one or more protrusions formed by the protrusion forming unit to provide an enlarged section on one or more protrusions for facilitating engagement between the friction surface and the friction pad material.

7. The brake backing plate treating apparatus as claimed in claim 6 wherein each protrusion has a proximal end where the protrusion is protruding out of the friction surface and a distal end opposing to the proximal end, and the deforming unit comprises a deforming plate for deforming the distal end of one or more protrusions.

8. The brake backing plate treating apparatus as claimed in claim 7 wherein the deforming plate is activated to press the distal end of one or more protrusions.

9. The brake backing plate treating apparatus as claimed in claim 7 wherein the protrusion forming unit has a press for,pressing the multiple blades onto the friction surface of the brake backing plate, and the deforming plate is activated by the press.

10. The brake backing plate treating apparatus as claimed in claim 7 wherein the position of the deforming plate is adjustable relative to the friction surface of the plate.

11. The brake backing plate treating apparatus as claimed in claim 6 further comprising a conveyer for conveying brake backing plates from the protrusion forming unit to the deforming unit.

12. A method for treating brake backing plates, the method comprising steps of:
forming multiple protrusions on a friction surface of a brake backing plate which receives a friction pad material; and
deforming one or more protrusions to provide an enlarged deformed section on the one or more protrusions for facilitating engagement between the friction surface and the friction pad material.

13. The method as claimed in claim 12 wherein each protrusion has a proximal end where the protrusion is protruding out of the friction surface and a distal end opposing to the proximal end, and the deforming step presses the distal end of one or more protrusions.

14. The method as claimed in claim 13 wherein the deforming step presses the distal end of one or more protrusions on a brake backing plate simultaneously with the forming step forms protrusions on a different brake backing plate.

15. The method as claimed in claim 12 wherein the forming step displaces portions of the friction surface to form protrusions and corresponding recesses.

16. The method as claimed in claim 12 further comprising a step of conveying the brake backing plate after the forming step to perform the deformation step on the brake backing plate.
